(19) United States
(12) Patent Application Publication
(10) Pub. No.: US 2009/0219947 A1
(43) Pub. Date: Sep. 3, 2009

(54) Communication device, communication method, and data structure

(75) Inventor: Hiroshi Kariya, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/379,040

(22) Filed: Feb. 11, 2009

(30) Foreign Application Priority Data
Feb. 29, 2008 (JP) 2008-049304

(51) Int. Cl. H04J 3/02

(52) U.S. Cl. 370/462

(57) ABSTRACT

A communication device communicates by reserving a Medium Access Slot (MAS) based on WiMedia_Alliance. The communication device includes a control part that generates negotiation request information, the negotiation request information requesting a reservation change so that an own device uses a MAS having been reserved by other communication device, and a host controller that sends the negotiation request information to the other communication device and receives a response accommodating the reservation change from the other communication device. After receiving the response, the control part sets a MAS reserved by the other communication device to as a MAS used by the own device.

### BACKGROUND

1. Field of the Invention

The present invention relates to a reservation method of a MAS (Medium Access Slot) defined in WiMedia_Alliance.

2. Description of Related Art

In a wireless USB (Universal Serial Bus) (hereinafter referred to as WUSB as appropriate), an access control method with a schedule unique to the WUSB is defined with a common platform defined in WiMedia_Alliance. In the WiMedia_Alliance, a superframe is formed of 256 MASs (hereinafter also referred to as slot as appropriate). The WiMedia_Alliance is an organization that defines, certifies, and supports enabling wireless technology for multimedia applications. It promotes and enables the rapid adoption, regulation, and standardization of ultra-wideband (UWB) worldwide. The 256 MASs include a region for transmitting and receiving a beacon (BP: hereinafter referred to as beacon period) and a region for transmitting and receiving a data frame by each device (data frame region). The 256 MASs are divided into 16 zones.

Each device specifies the MAS that will be a reservation target by the zone and the position of the MAS in the zone, and reserves the MAS in advance to use the MAS for transmitting and receiving the data frame. When the MAS is reserved in each zone, the MAS is secured in the order of requiring the reservation. In other words, the MAS is secured in the order of reservation. As such, when a plurality of devices share the same system, the MAS which is required in the own device may not be secured. In reserving the MAS, the number of MASs that can be secured by one device (hereinafter referred to as reservation specified number) is determined. The MASs that are secured for more than the reservation specified number can be opened. On the other hand, when the number of MASs is within the reservation specified number, the device needs to wait for other devices to open the MAS. As such, when the number of devices increases, there are devices that cannot secure the MASs sufficiently, which decreases the efficiency of the data transfer.

Further, the MAS should be reserved from the end part of each zone when the number of devices reserving the MAS increases or the device requires additional MAS. As such, the MASs are often reserved discontinuously, which decreases the efficiency of the data transfer.

For example, assume a case in which the MAS is reserved as in FIG. 16. Although a device #E reserves MASs 10, 11, 14, and 15, the MASs are discontinuous. The device #E waits for other devices, in this example, a device #D, to open the MASs. When the MASs 8, 9, 12, and 13 are opened when the device #D is absent, the device #E is able to newly reserve the MASs. For example, the device #E is able to continuously use the MASs of 12 to 15. Further, the MASs of 8 to 11 are opened.

Japanese Unexamined Patent Application Publication No. 2007-19604 discloses a radio communication system capable of realizing access control with a micro-schedule unique to a WUSB when only a common platform defined in WiMedia_Alliance is mounted in the WUSB.

As stated above, in the WiMedia_Alliance, the MAS is reserved regardless of the characteristics of a communication system including the own device. Accordingly, there is a possibility that an optimal reservation cannot be performed depending on devices. For example, some devices, such as a printer, an external recording medium, which transfer large-volume data, may not be suitable.

One measure to overcome such a situation includes assignment of slots. However, although the assignment may be requested for the MAS having low priority, it is not possible to request the assignment for the MAS having high priority. Even when the data transfer efficiency can be improved by exchanging the MASs which are reserved discontinuously, there is no means to adjust the reserved MASs. Japanese Unexamined Patent Application Publication No. 2005-323375 discloses a technique of detecting and solving a reservation conflict that may occur in a process of reserving the data slot. However, a technique of adjusting the MAS which has already been reserved is not disclosed.

### SUMMARY

The present inventors have found a problem as follows. When a common platform defined in WiMedia_Alliance is used in WUSB, there is no means to adjust the reserved MASs by assignment or exchange of the MASs with other devices that secure the MASs within the reservation specified number.

A first exemplary aspect of an embodiment of the present invention is a communication device comprising a control part that generates negotiation request information, the negotiation request information requesting a reservation change so that an own device uses a slot having been reserved by an other communication device, and a host controller that sends the negotiation request information to the other communication device and receives a response accommodating the reservation change from the other communication device. After receiving the response, the control part sets a slot reserved by the other communication device as a slot used by the own device.

By setting the mechanism in which the negotiation request information is transmitted by adding it to a beacon, it is possible for the own device to use the MAS which is reserved by other communication devices. Accordingly, it is possible not only to wait for other communication devices to open the MAS, but also to proactively increase the number of MASs that can be used or secure the alignment of the MASs which will be transferred with high efficiency.

A second exemplary aspect of an embodiment of the present invention is a communication method comprising sending negotiation request information from a first device to a second device, the negotiation request information requesting to change a reservation so that the first device uses a slot having been reserved by the second device, responding an acceptance of a reservation change by the second device based on the negotiation request information, and using the slot having been reserved by the second device by the first device after making a response.

A third exemplary aspect of an embodiment of the present invention is an information data structure that is tangible embedded in a computer readable medium, the information data structure comprising a data frame to be included in a beacon, wherein the data of the data frame specifies a slot number having been reserved by a first device and a reserved slot number having been reserved by a second device so as to change each other.

By defining such a data structure, it is possible to add to the beacon the information element requiring the exchange of the reserved MASs from the first device to the second device.

According to the present invention, it is possible to provide a means for adjusting the reserved MAS by the assignment or the exchange of the MASs for other devices that secure the MASs within the reservation specified number. Accordingly, the data transfer efficiency can be enhanced.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 shows a configuration example of a device according to a first exemplary embodiment of the present invention;

FIG. 2 shows a configuration example of a superframe;

FIG. 3 shows a frame format of a DRP IE;

FIG. 4 shows a configuration example for describing a zone bit map and a MAS bit map;

FIG. 5 shows an example of the frame format of a negotiation IE;

FIG. 6 shows an example of a reservation status of a MAS in performing assignment negotiation;

FIG. 7 shows a setting of the negotiation IE when a device #E performs the assignment negotiation, and a status of a countdown value;

FIG. 8 shows an update timing of a beacon when the negotiation is successfully established;

FIG. 9 shows an update timing of a beacon when the negotiation fails;

FIG. 10 shows one example of the reservation status of the MAS in performing exchange negotiation;

FIG. 11 shows a setting of the negotiation IE when the device #E performs the exchange negotiation, and a status of the countdown value;

FIG. 12 is a flow chart showing an operation example of a MAC control driver in an Owner side requesting the assignment or the exchange of the MASs;

FIG. 13 is a flow chart showing the detail of a negotiation processing of the MAC control driver in the Owner side;

FIG. 14 is a flow chart showing the operation example of a MAC control driver in a Target side receiving the request of the assignment or the exchange of the MAS;

FIG. 15 is a flow chart showing the operation example of a built-in CPU of a host controller in the Owner side; and

FIG. 16 shows one example of a related reservation status of a MAS.

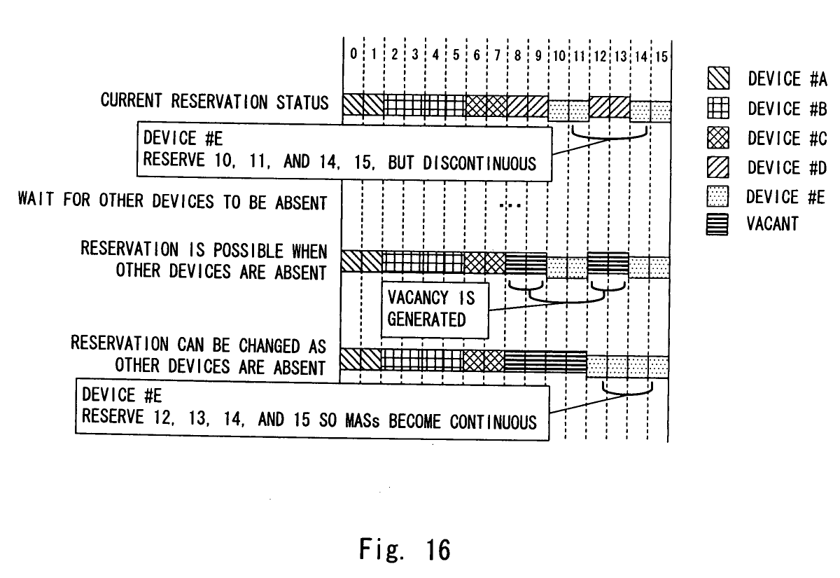

### DETAILED DESCRIPTION OF THE EXEMPLARY EMBODIMENTS

The exemplary embodiment of the present invention will be described with reference to the drawings. Some of the following description and the accompanying drawings are omitted or simplified as appropriate for the sake of clarity. The components having the same configuration and the function throughout the drawings are denoted by the identical reference symbols, and the overlapping description will be omitted.

In the exemplary embodiment, an Application Specific IE is newly defined so that an own device makes a request to other devices (Neighbor) for allowing the own device to use a MAS reserved by the other devices regarding a method of reserving the MAS defined in WiMedia_Alliance. More specifically, a DRP Change IE (hereinafter also referred to as “negotiation IE” or “negotiation request information”) is generated as the Application Specific IE. The negotiation IE is used to conduct negotiation between the own device and the other devices so that the MAS reserved by the other devices can be changed to the reservation by the own device, so as to increase the number of MASs that can be used by the own device. Accordingly, the bandwidth required for the own device to perform transfer or the bandwidth for enhancing the efficiency of transfer by the own device are secured. In general, two methods for changing the reservation will be suggested: one is to require assignment of the MAS, and the other is to require exchange of the the MASs.

In the WiMedia_Alliance, two transmission methods of DRP (Distributed Reservation Protocol) and PCA (Prioritized Contention Access) are specified. The DRP is the method in which the MAS is reserved for transmission in advance, the other devices are notified of the reservation information by a beacon, and only the transmission within a fixed time is possible. The PCA is the method in which data can be freely transmitted in other MASs than the beacon period and DRP-reserved MAS. In the PCA, there is a possibility that contention occurs with the other devices, and therefore, it is not always necessary that the transmission operation can be made possible at desired time. In WUSB, the data transfer in the DRP is employed. The detail of the exemplary embodiment of the present invention will now be described.

### First Exemplary Embodiment

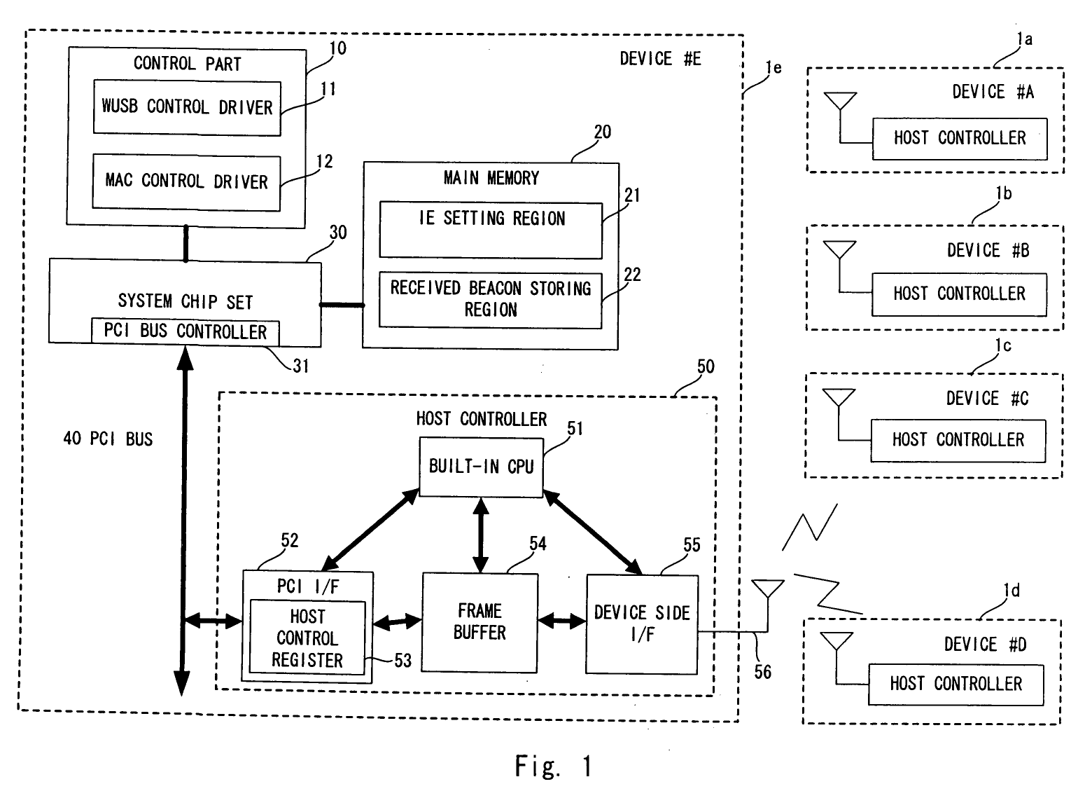

FIG. 1 shows a configuration example of a device according to a first exemplary embodiment of the present invention. In FIG. 1, devices 1a to 1e are shown; and in the following description, the device 1e will be described as an own device, and devices 1a to 1d will be described as other devices (other communication devices). The devices 1a to 1e are communication devices performing communication using WUSB, and may have a communication function of WUSB in an information processing device. Although only detailed configuration example of the device 1e is shown, the devices 1a to 1e have the same configuration. Further, in the following description, each device is shown as devices 1a to 1e or devices #A to #E for the purpose of making a distinction among the devices. However, when there is no need to make a distinction, the devices are simply referred to as device 1.

The device 1 includes a control part 10, a main memory 20, a system chip set 30, a PCI (Peripheral Component Interconnect) bus 40, and a host controller 50. The control part 10 includes a WUSB control driver 11 and a MAC control driver 12. The main memory 20 includes an IE setting region 21 and a received beacon storing region 22. The system chip set 30 includes a PCI bus controller 31. The host controller 50 includes a built-in CPU (Central Processing Unit) 51, a PCI I/F (interface) 52, a host control register 53, a frame buffer 54, a device side I/F 55, and a radio part 56.

The control part 10 is a CPU controlling each component in the own device including the host controller 50. The control part 10 manages the reservation of the MAS of the own device, generates a DRP IE (Distributed Reservation Protocol Information Element) in order to secure a required bandwidth, and has the host controller 50 transmit the DRP IE to the other device. The DRP IE will be described later. Further, in the first exemplary embodiment, the control part 10 generates a negotiation IE which requires use of slots reserved by the other devices. The negotiation IE will also be described later in detail. The control part 10 includes a WUSB control driver 11 and a MAC control driver 12 as a specific example realizing these functions.

The WUSB control driver 11 calculates the bandwidth (number of MASs) required for the data transfer and notifies the MAC control driver 12 of the bandwidth.

The MAC control driver 12 generates IEs (information elements) such as the negotiation IE, the DRP IE for performing the MAS reservation based on the request of the WUSB control driver 11.

The main memory 20 is a universal memory used by the control part 10 for processing. The IE setting region 21 is a region in which the IE that would be transmitted by the control part 10 is written. The IE which is written is transmitted by the host controller 50. The received beacon storing region 22 is a region in which the beacon received by the host controller 50 is written. The beacon which is written is read into the control part 10.

The system chip set 30 executes PCI transfer between the control part 10 and the main memory 20. The PCI bus controller 31 controls the PCI bus 40.

The PCI bus 40 is a universal bus, and transfers the data among the control part 10, the main memory 20, and the host controller 50.

The host controller 50 is connected to the PCI bus 40, and carries out WUSB communication between the own device and the other devices.

The built-in CPU 51 controls an internal block and the CPU in the host controller 50.

The PCI I/F 52 carries out the transfer between the frame buffer 54 and the PCI bus 40.

The host control register 53 is a register in which data is read/written by the control part 10 for controlling the host controller 50.

The frame buffer 54 is a buffer holding the frame (data frame, IE) transmitted or received by the device 1.

The device side I/F 55 carries out the transfer between the frame buffer 54 and the radio part 56.

The radio part 56 carries out radio communication of the WUSB.

Now, the reservation method of the MAS and the mechanism for canceling the conflict in the reservation of the MAS will be described for the purpose of explaining the summary of the communication method according to the exemplary embodiment of the present invention.

### <Superframe and MAS>

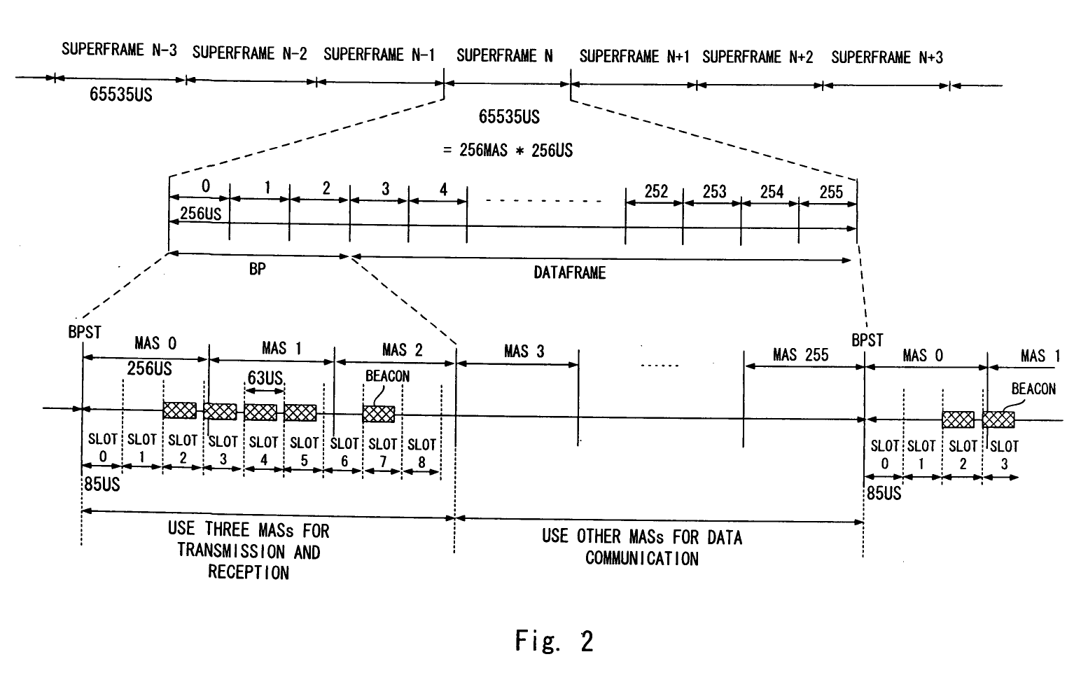

In the WiMedia_Alliance, the superframe is formed by repeating the period of the length of 65536 μs, and formed of 256 MASs (256 μs). The data transfer is realized by repeating the unit of the superframe. In each superframe, a beacon period is set at the head of it, and the remaining part is the data frame. FIG. 2 shows a configuration example of the superframe. A beacon period (BP) is set from the head of the superframe, more specifically, from the point at which the superframe timer is zero. A start time of the beacon period is called BPST (Beacon Period Start Time). The beacon transmits various information for control.

Further, in DataFrame, MASs other than the beacon period are allocated, and are used for the data transfer between devices.

### <DRP>

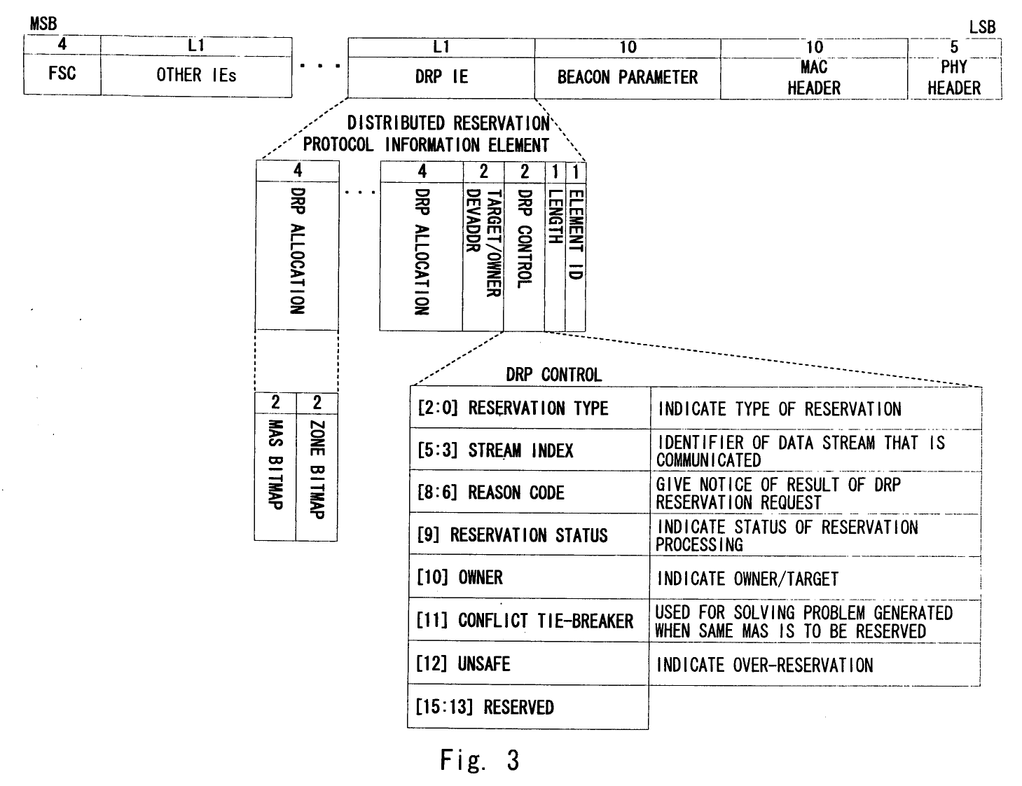

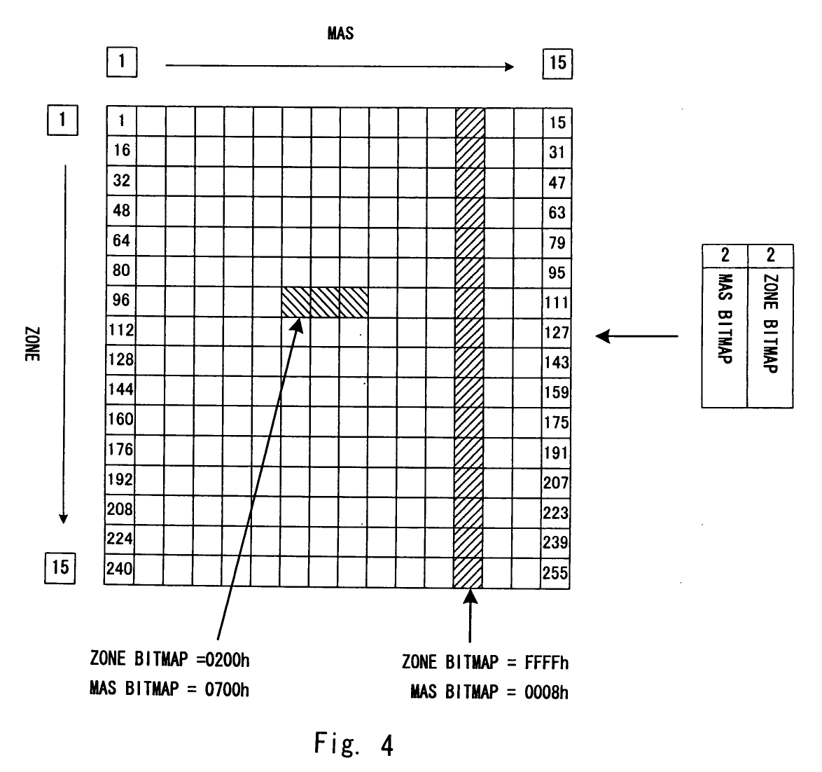

All the devices performing transmission and reception using the distributed reservation protocol (DRP) notifies the peripheral part of which MAS is reserved by adding the DRP IE to the beacon. FIG. 3 shows a frame format of the DRP IE. Further, FIG. 4 shows a configuration example describing a zone bit map and a MAS bit map. The MAS reservation is specified by the following field values in the DRP IE: Target/Owner, DevAddr, Owner, Reservation Type, and Stream Index. The reservation; Owner is the device starting the reservation, and the frame transaction is started within the reservation. The reservation; Target is the device in which the MAS is reserved by the reservation Owner. In WUSB, the reservation Owner corresponds to the host, and the reservation Target corresponds to the device. The host receives Beacons of other hosts of the peripheral part, determines the MAS used by itself among the MASs that are vacant, and notifies the periphery of the MAS by using DRP IE. Upon determination of the MAS reservation, the DRP IE transmitted by the device=Target is transferred by WUSB transfer (Control transfer). The device does not generate the DRP IE by itself, but transmits the DRP IE which is transferred by the host by adding it to the Beacon of itself. Accordingly, there is no need to perform negotiation between the host and the device, and the Reservation Status becomes 1 from the first stage.

The DRP IE is included in the beacon and is transmitted, so as to declare the use of the MAS to the peripheral devices.

In each device 1, the MAC control driver 12 and the host controller 50 play a role in the DRP as follows. The host controller 50 analyzes the DRP IE of the received beacon. Then, the host controller 50 generates Availability information of the MAS after the analysis; and when there is a change, the host controller notifies the MAC control driver 12 of the change. Further, upon detection of the Conflict of the DRP reservation, the host controller 50 notifies the MAC control driver 12 of the conflict.

The MAC control driver 12, after determining the number of MASs (bandwidth) that will be reserved, notifies the host controller 50 of the number of MASs. The host controller 50 generates the beacon that is to be transmitted and transmits the generated beacon based on the notification (request) from the MAC control driver 12.

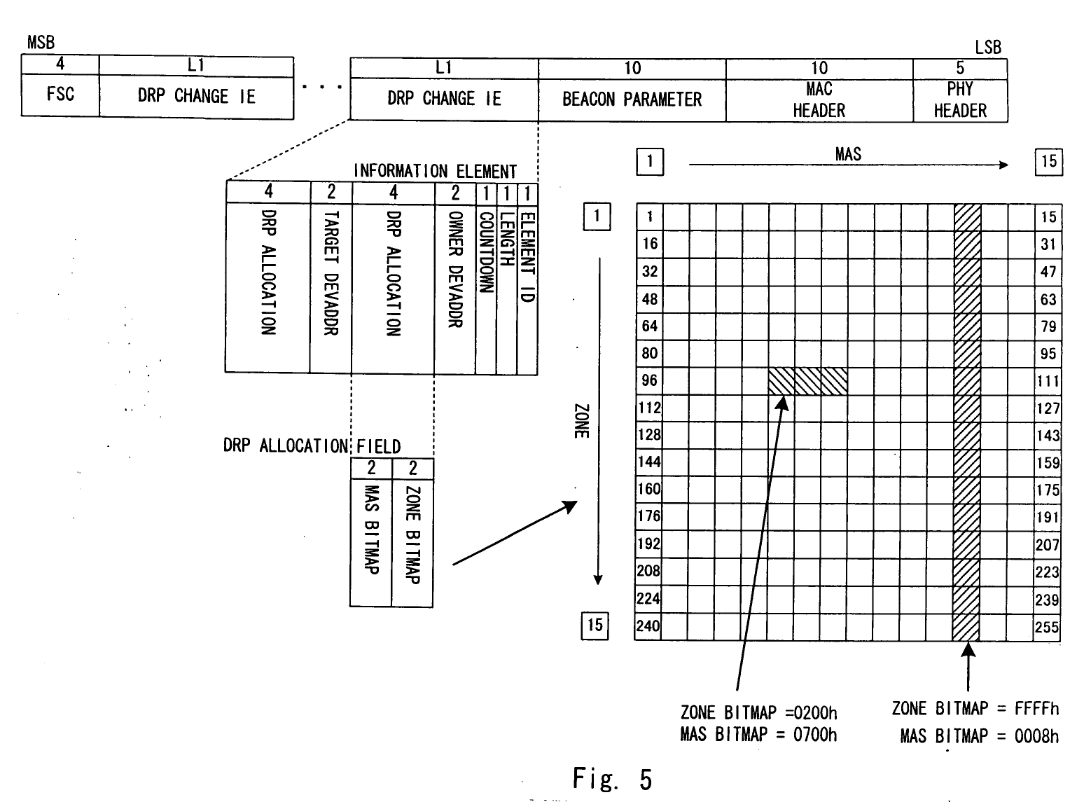

Next, the Application Specific IE that is newly defined in the first exemplary embodiment will be described. FIG. 5 shows one example of a frame format (DRP Change IE Frame Format) of the negotiation IE that is newly defined in the first exemplary embodiment. The frame format of the negotiation IE shown in FIG. 5 includes the following elements.

Element ID is an identifier identifying the IE requiring the assignment or the exchange of the MASs, and indicated by a fixed value.

Length is the number of bytes of the whole IE.

CountDown is a countdown value for synchronizing with the other peripheral devices.

Owner DevAddr is an address of a device requiring the negotiation.

Target DevAddr is a device address of the negotiating partner.

DRP Allocation specifies the MAS of the negotiation target. The target is specified by specifying a zone obtained by dividing the 256 MASs into 16 parts and 16 MASs in the zone.

The device transmits the negotiation IE shown in FIG. 5 in the beacon period to require the change of the reservation of the MAS of the other devices. When the other devices in which the reservation change of the MAS is requested respond to the reservation change, the information identifying the MAS in which the change is required is set in the negotiation IE with Owner DevAddr to respond as a response IE. When the reservation change of exchange is required, the data format shown in FIG. 5 includes a structure in which a request source device requiring the reservation change, a request destination device in which the exchange is requested, and the MAS number which is the target of exchange can be identified, whereby the MASs reserved by each of the own device and the other devices can be exchanged. Further, in case of the assignment, the data format shown in FIG. 5 includes a structure in which the request source device requiring the reservation change, the request destination device in which the exchange is requested, and the MAS number which is the target of assignment can be identified.

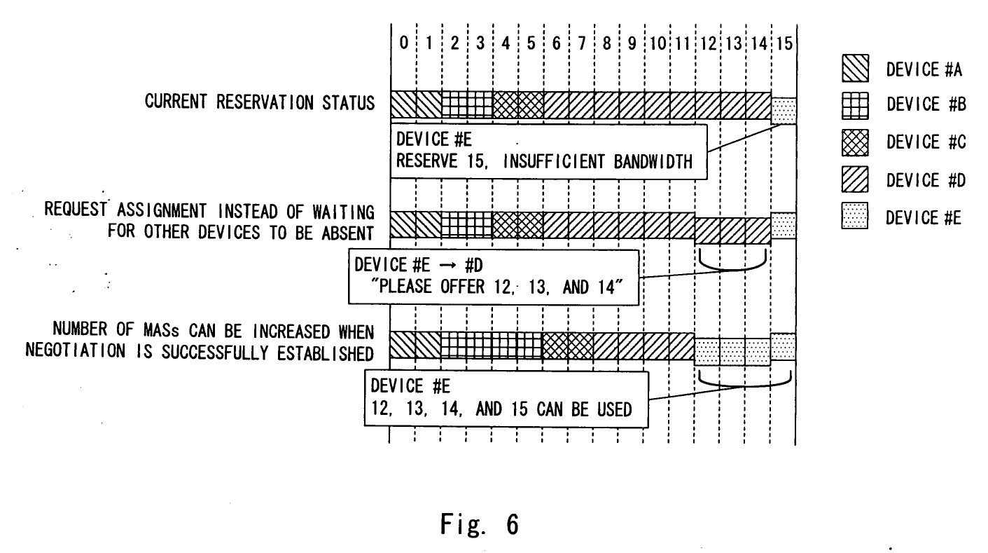

Referring now to FIGS. 6 to 9, the overall operation of requiring the assignment of the MAS from the own device to the other devices will be described. FIG. 6 shows one example of a reservation status of the MAS. FIG. 6 shows a reservation status of one zone, and shows an example in which the MAS is reserved by five devices. The device requiring the change of reservation is called device #E (corresponding to the device 1e in FIG. 1), and the device in which the reservation change is requested is called device #D (corresponding to the device 1d in FIG. 1). As shown in the upper stage, in the current reservation status, although the device #E reserves a 15-th MAS, the bandwidth of the data transfer that is needed is insufficient. As shown in the middle stage, the device #E considers performing the assignment negotiation instead of waiting for the other devices to open the MAS. In this example, the device #E considers the assignment of three MASs by the device #D so as to be able to secure the continuous bandwidth. As shown in the lower stage, as the device #D responds to the assignment of the MASs of 12 to 14 after responding to the negotiation, the device #E employs four MASs of 12 to 15.

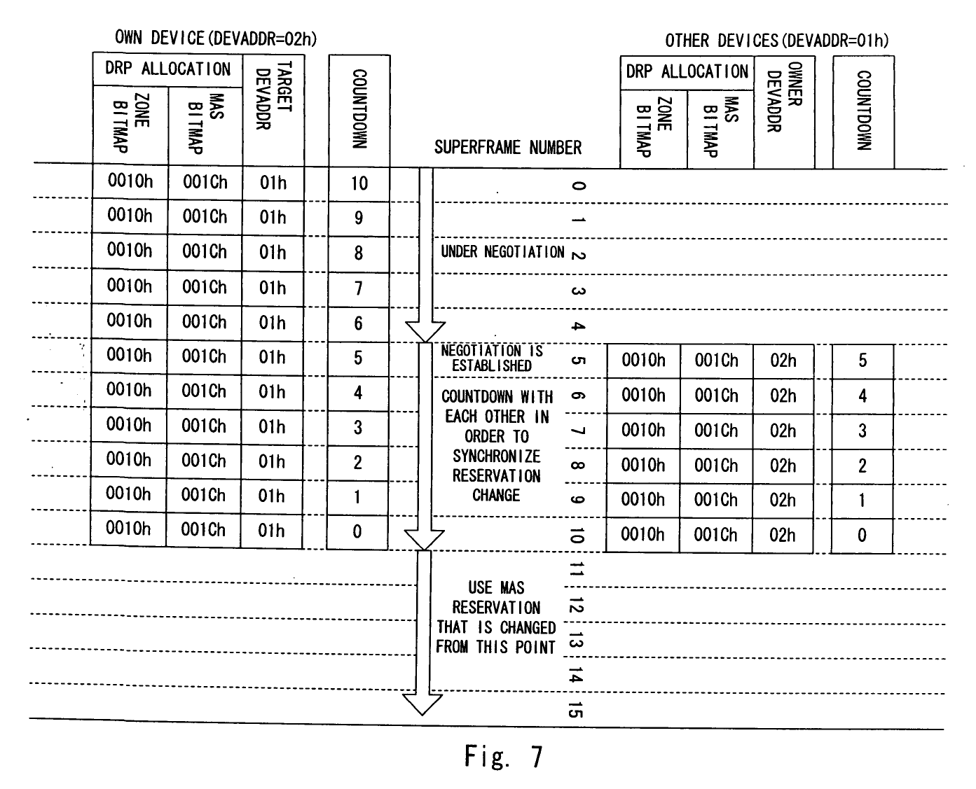

FIG. 7 shows a setting of the negotiation IE when the device #E performs the assignment negotiation, and a state of a countdown value (Countdown). The device #E sets an address 01h of the device #D in which the assignment of the MAS is required in the Target DevAddr of the negotiation IE, and sets the MAS in which the assignment is required in the DRP Allocation. Then, the countdown is started as setting the superframe that transmits the negotiation IE as the countdown value 10. In FIG. 7, the negotiation is successfully established in the countdown value 5, and the device #D sets an address 02h of the device #E in the Owner DevAddr and starts to transmit the response IE in which the MAS which will be assigned is set in the DRP Allocation. The device #E receives the MAS from the device #D from a frame next to the frame in which the countdown value becomes 0.

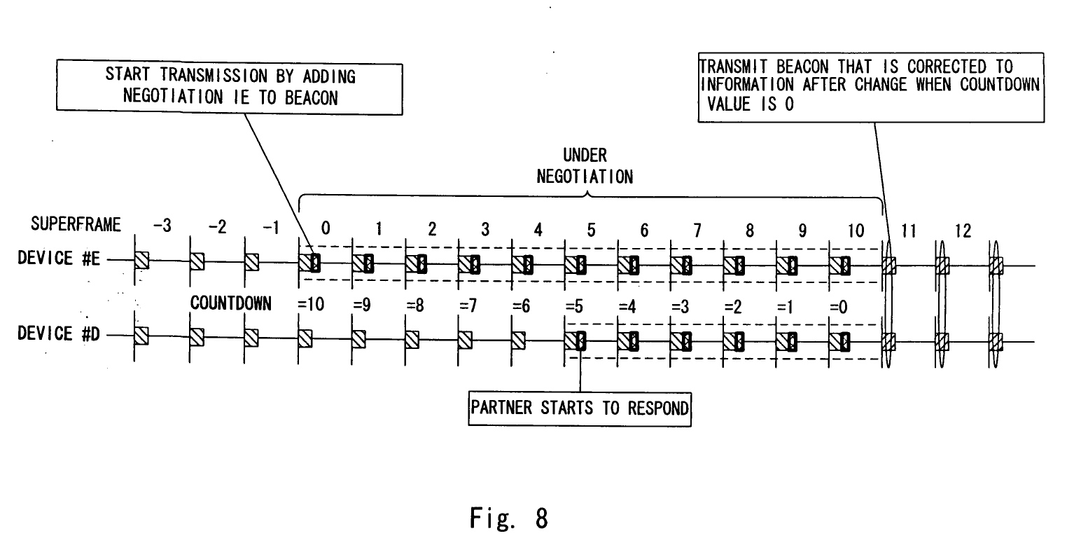

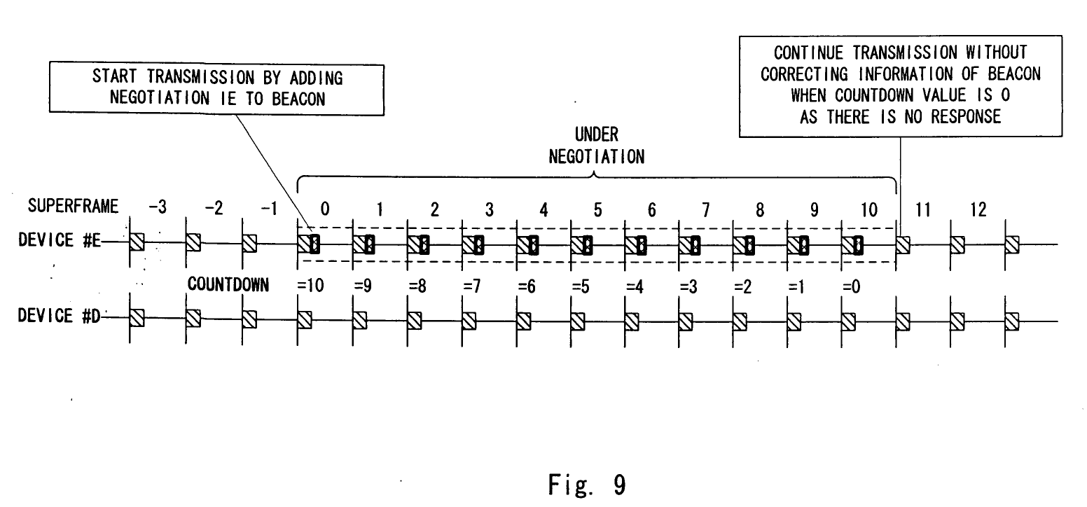

FIG. 8 shows an update timing of the beacon when the negotiation is successfully established, and FIG. 9 shows an update timing of the beacon when the negotiation fails. When the superframe is 0, the countdown value is 10, and the device #E starts transmission by adding the negotiation IE to the beacon. The device #E keeps transmission of the beacon to which the negotiation IE is added until when the countdown value becomes 0. In FIG. 8, when the countdown value is 5, the device #D starts response by adding the response IE to the beacon. After the device #D responds once, the response is repeated until when the countdown value becomes 0. Both of the device #E and the device #D transmit the beacon in which the MAS reservation status is changed when the countdown value is 0. In FIG. 9, there is no response from the device #D; and therefore, the device #E stops adding the negotiation IE to the beacon when the countdown value becomes 0. Further, as the negotiation is not successfully established, the information of the beacon is not updated.

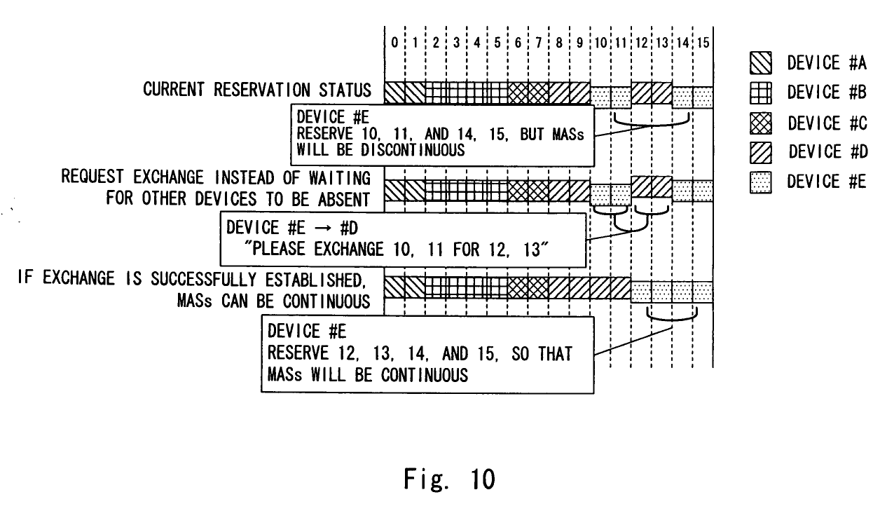

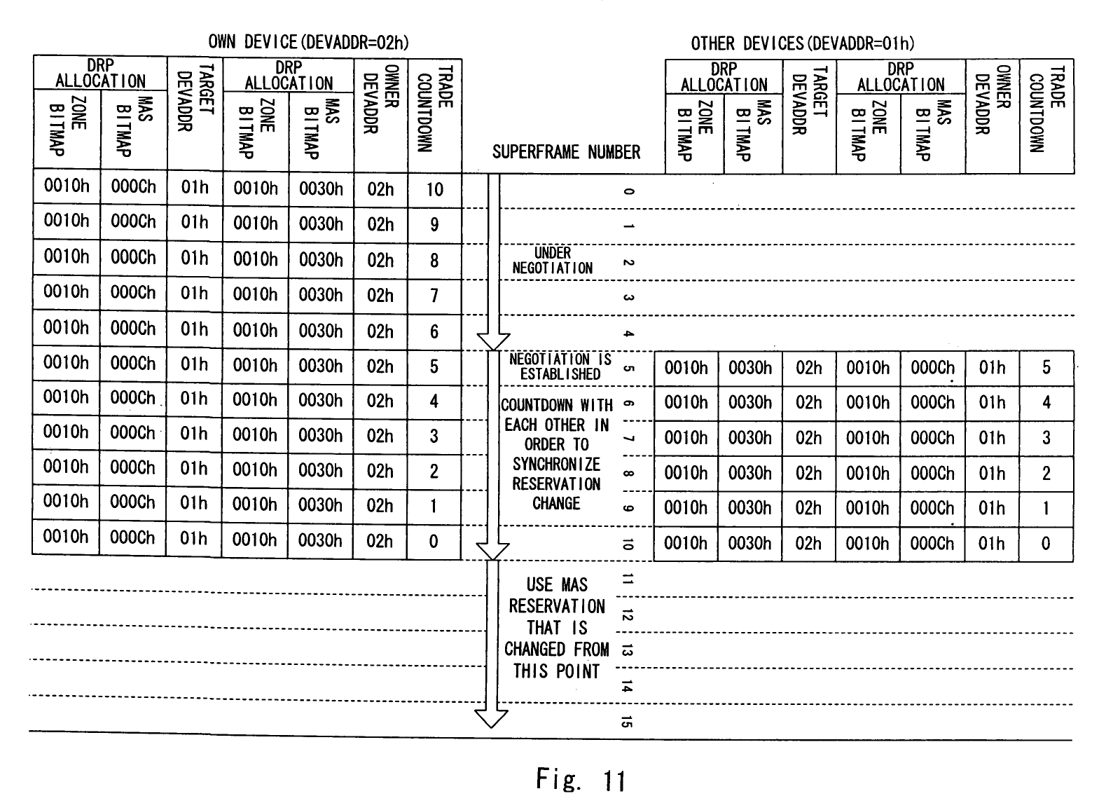

Next, the schematic operation when the own device requires the exchange of the reserved MASs of the other devices will be described. FIG. 10 shows one example of the reservation status of the MAS, and FIG. 11 shows a setting of the negotiation IE and the status of the countdown regarding a case in which the MASs are exchanged. FIG. 10 also shows a case of reserving the MAS by five devices, as is the same as FIG. 6. In FIG. 10, as shown in the upper stage, the device #E reserves the discontinuous MASs. If the continuous MASs can be secured, the efficiency of the data transfer is improved. Thus, the device #E starts to negotiate the exchange of the MASs with the MAS reserved by the device #D (middle stage in FIG. 10). When the exchange is successfully established, the device #E is able to use the continuous MASs of 12 to 15, and the device #D is able to use the continuous MASs of 8 to 11 (lower stage in FIG. 10).

Further, as shown in FIG. 11, the device #E sets the address 01h of the device #D in which the exchange of the MASs is requested in the Target DevAddr of the negotiation IE, and sets the MAS in which the exchange is requested in the DRP Allocation. Further, the address 02h of the own device is set in the Owner DevAddr, and sets the MAS which is reserved by the own device and requiring the exchange is set in the DRP Allocation. Then, the countdown is started by setting the superframe transmitting the exchange IE as the countdown value 10. In FIG. 11, the negotiation is successfully established when the countdown value is 5, and the device #D sets the address 02h of the device #E in the Target DevAddr, sets the address 01h of the device #D in the Owner DevAddr, and starts to transmit the response IE in which the MAS for assignment is set in each DRP Allocation. The device #E and the device #D exchange MASs from a frame next to the frame in which the countdown value becomes 0.

Next, the detail of the negotiation control operation according to the exemplary embodiment will be described. In this example, explanation will be made by assuming the reservation status of the MAS such as FIG. 6 or 10. Further, the configuration of the device is the same as the configuration example shown in FIG. 1. The Owner side and the Target side both have the similar configuration, and the same symbols are used without making a distinction.

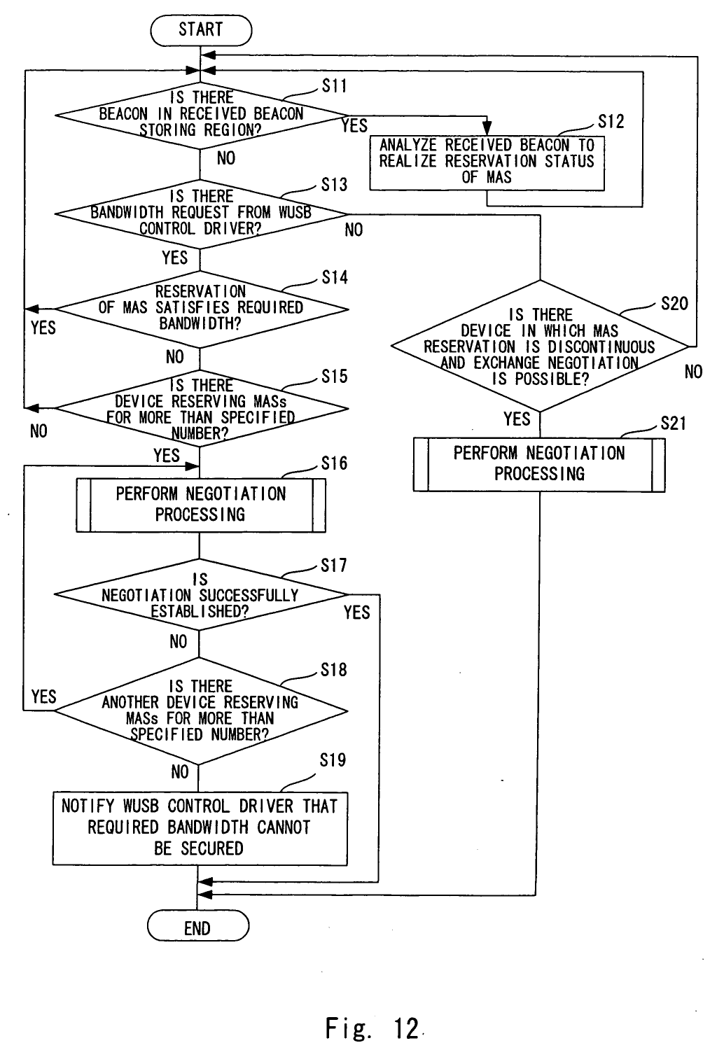

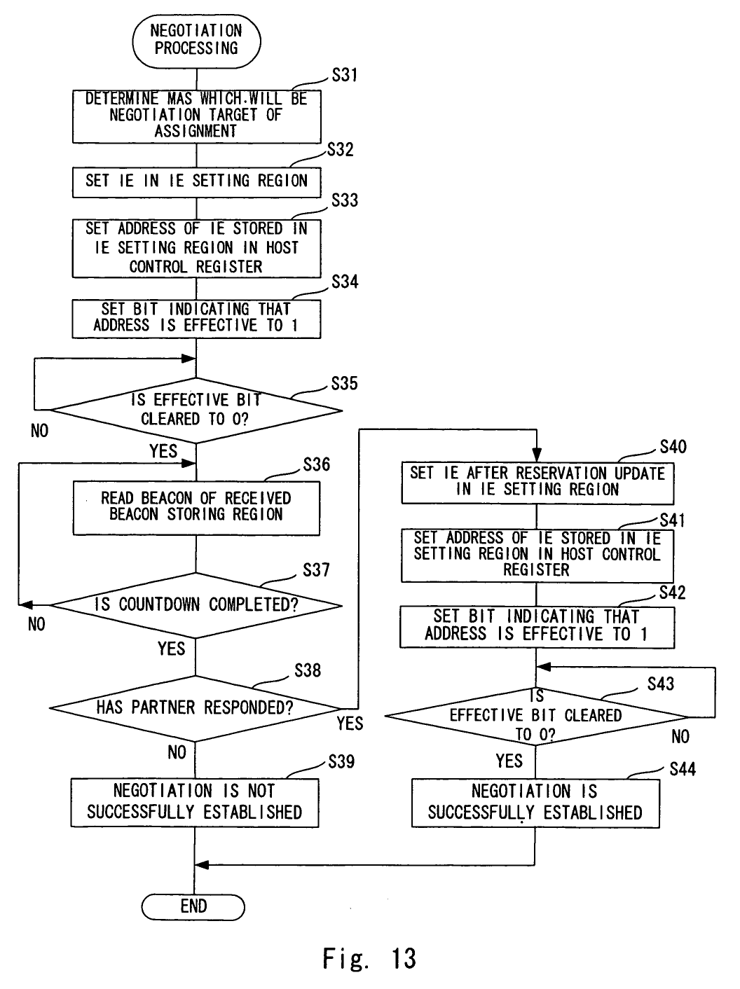

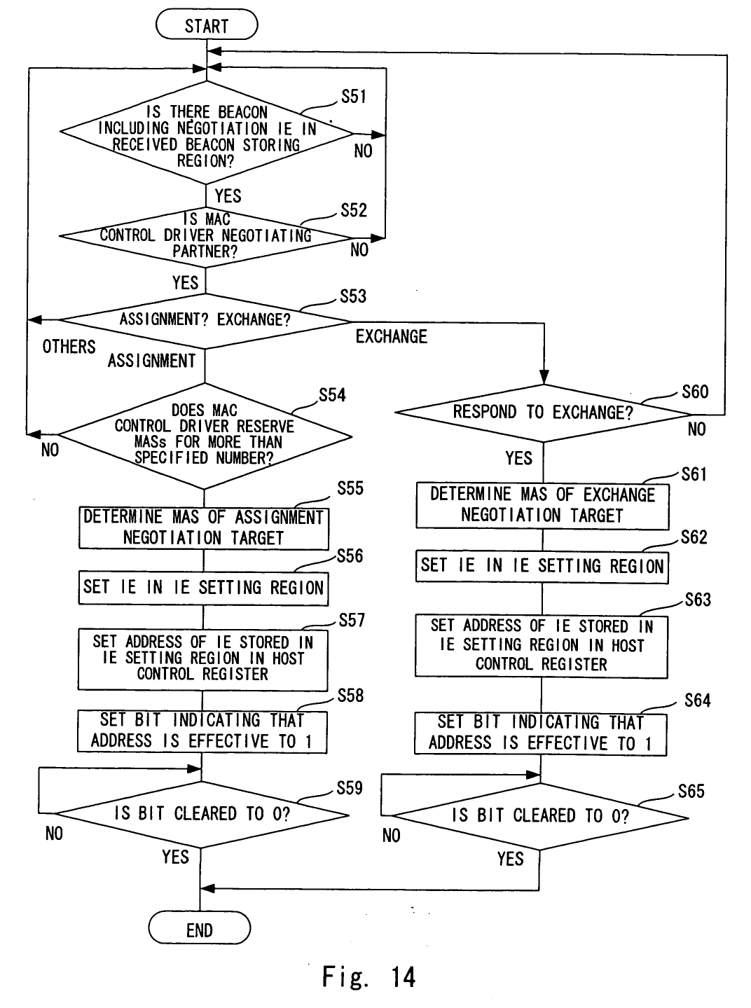

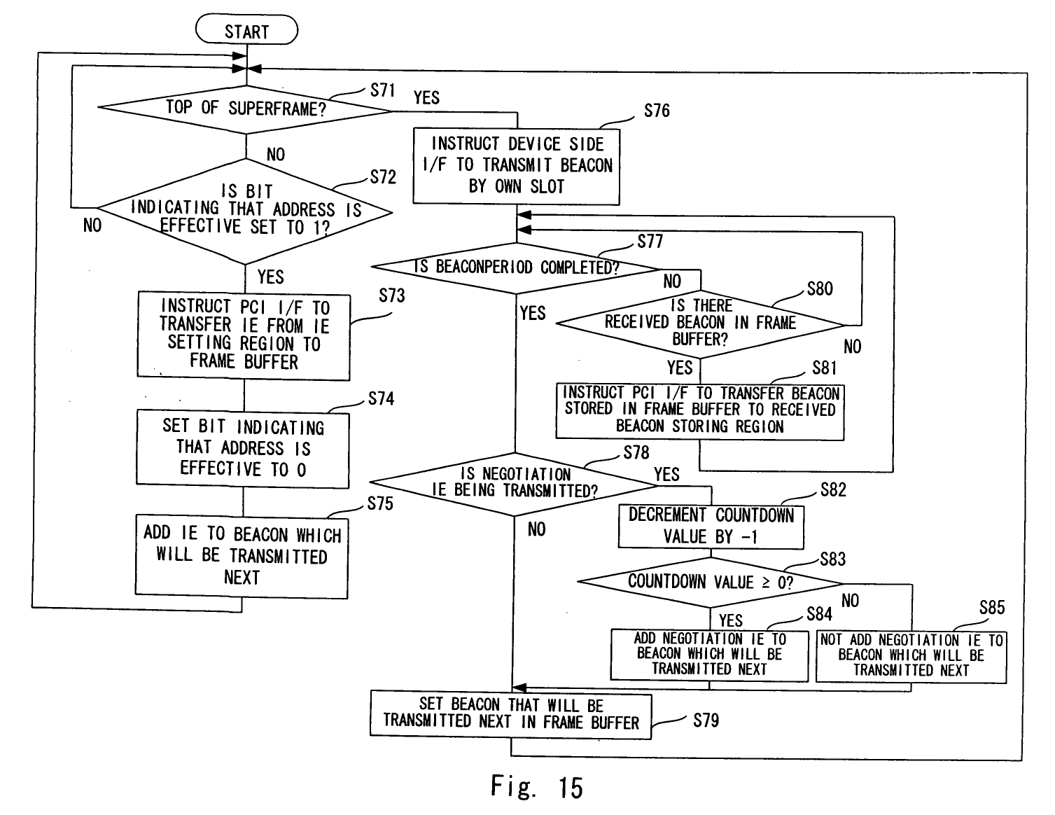

FIGS. 12 and 13 are flow charts showing the operation example of the MAC control driver in the Owner side requesting the assignment or the exchange of the MASs. Further, FIG. 14 is a flow chart showing the operation example of the MAC control driver in the Target side in which the assignment or exchange of the MAS is required. FIG. 15 is a flow chart showing the operation example of the built-in CPU of the host controller in the Owner side.

First, the description will be made on the operation in which the MAC control driver 12 in the Owner side requests the negotiation. More specifically, the operation is made in the device #E in FIG. 6 or FIG. 10. The MAC control driver 12 checks whether the beacon is stored in the received beacon storing region 22 of the main memory 20 (S11). When the beacon is stored (YES in S11), the MAC control driver 12 analyzes the received beacon to realize the reservation status of the MAS (S12). When the beacon is not stored (NO in S11), it is checked whether there is a bandwidth request from the WUSB control driver 11 (S13). When there is a request (YES in S13), the MAC control driver 12 determines whether the current reservation status of the MAS satisfies the required bandwidth (S14). When it is satisfactory (YES in S14), the process goes back to step S11.

When it is not satisfactory (NO in step S14), it is checked whether there is a device reserving the MASs for more than specified number (S15). When there is no device reserving the MASs for more than specified number (NO in S15), the process goes back to step S11. When there is a device reserving the MASs for more than specified number (YES in S15), the negotiation processing is started for requiring the assignment of the MAS of the device (S16). When the assignment negotiation is performed, the device which may be the negotiating partner is determined in accordance with the following rule. A quotient (negotiable number) obtained by dividing the total number of MASs, 256, for example, by the total number of devices transmitting the beacon is compared with the total number of the MASs reserved by the own device. When the reserved MAS is more than the quotient, the device in which the assignment is required needs to respond to the assignment negotiation. When there is a device reserving the MASs for more than specified number as a result of applying the rule, in other words, when there is a device reserving the MASs for more than negotiable number, the device can be selected as a negotiating partner. In this embodiment, the quotient obtained by dividing the total number of MASs by the total number of devices transmitting the beacon is the negotiable number. However, other values may be used instead. The negotiable number may be a predetermined value as well.

The MAC control driver 12 completes the processing when the negotiation is successfully established (YES in S17), and the MAC control driver 12 checks whether there is another device reserving the MASs for more than specified number (S18) when the negotiation is not successfully established (NO in S17). When there is another device which may be the negotiation target (YES in S18), the MAC control driver 12 repeats the processing from step S16; and when there is no negotiation target (No in S18), the MAC control driver 12 notifies the WUSB control driver 11 that the required bandwidth cannot be secured (S19) to terminate the processing.

Further, when there is no bandwidth requirement from the WUSB control driver 11 (NO in S13), the MAC control driver 12 checks whether there is a device in which the MAS reservation is discontinuous and the exchange negotiation can be possible (S20). When there is a device which may be the target (YES in S20), the MAC control driver 12 performs the negotiation processing requiring the exchange of the MASs of the device (S21) to terminate the processing. When there is no device which may be the target (NO in S20) the process goes back to step S11.

Now, the detail of the negotiation processing performed in step S16 and step S21 in FIG. 12 will be described with reference to FIG. 13. First, the MAC control driver 12 determines the MAS which may be the negotiation target of the assignment or exchange (S31). Then, the MAC control driver 12 sets the negotiation IE requiring the assignment or the exchange in the IE setting region 21 of the main memory 20 (S32). Further, the MAC control driver 12 sets the address of the negotiation IE stored in the IE setting region 21 in the host control register 53 in the host controller 50 (S33), and sets the bit indicating that the address is effective (hereinafter also referred to as effective bit) to 1 (S34). The effective bit can be any one as long as it is set in a region where both of the MAC control driver 12 and the built-in CPU 51 can access. For example, it may be set in the host control register 53.

The MAC control driver 12 waits until when the effective bit is cleared to zero by the built-in CPU 51 of the host controller 50 (S35). The fact that the effective bit is cleared to zero means that the negotiation IE has been transmitted by the host controller 50. When the effective bit is cleared to zero (YES in S35), the MAC control driver 12 reads the received beacon upon detecting that the beacon is stored in the received beacon storing region 22 (S36). At this time, the MAC control driver 12 is able to check whether there is included the response from the negotiating partner in the received beacon that is read in. When the countdown is not completed (NO in S37), the MAC control driver 12 goes back to step S36. When the countdown is completed (YES in S37) and the negotiating partner has not responded yet (NO in S38), the MAC control driver 12 completes the processing as the negotiation is not successfully established (S39). Further, when the countdown is completed (YES in S37) and the negotiating partner is responded (YES in S38), the MAC control driver 12 goes to step S40.

The MAC control driver 12 sets the DRP IE after reservation update in the IE setting region 21 (S40), sets the address of the IE stored in the IE setting region in the host control register (S41), and sets the effective bit to 1 (S42). The MAC control driver 12 waits until when the effective bit is cleared to zero by the built-in CPU 51 of the host controller 50 (S43), and terminates the processing as the negotiation is successfully established (S44) when the effective bit is cleared to zero (YES in S43).

Next, the operation of the MAC control driver 12 of the device which may be the negotiating partner will be described. For example, the operation in the device #D in FIG. 6 or 10 will be described. The MAC control driver 12 checks whether there is a beacon including the negotiation IE in the received beacon storing region 22 (S51). The MAC control driver 12 analyzes the negotiation IE, checks whether the MAC control driver 12 is the negotiating partner (YES in S52), and determines the assignment or the exchange (S53). When the MAC control driver 12 is not the negotiating partner (NO in S52), or when the other performance than the assignment or the exchange is specified even when it is the negotiating partner (others in S53), the process goes back to step S51.

When the negotiation ID is the assignment request (assignment in S53), the MAC control driver 12 goes back to step 51 when the own device does not reserve the MASs for more than specified number (NO in S54). Further, when the own device reserves the MASs for more than specified number (YES in S54), the MAC control driver 12 determines the MAS of the assignment negotiation target (S55) and sets the response IE in the IE setting region (S56). Further, the MAC control driver 12 sets the address of the response IE stored in the IE setting region in the host control register 53 (S57) to set the effective bit to 1 (S58). After the effective bit is cleared to zero by the host controller 50 (YES in S59), the MAC control driver 12 terminates the processing.

When the negotiation ID is the exchange request (exchange in S53), the MAC control driver 12 goes back to step 51 when it does not respond to the exchange request (NO in S60). On the other hand, when it responds to the exchange request (YES in S60), the MAC control driver 12 determines the MAS of the exchange negotiation target (S61) and sets the response IE in the IE setting region (S62). Further, the MAC control driver 12 sets the address of the response IE stored in the IE setting region in the host control register 53 (S63) and sets the effective bit to 1 (S64). After the effective bit is cleared to zero by the host controller 50 (YES in S65), the MAC control driver 12 terminates the processing.

Next, the detail of the operation of the built-in CPU 51 in the host controller 50 will be described with reference to FIG. 15. In this example, the operation of the built-in CPU 51 in the Owner side will be described. When it is not the top of the superframe (NO in S71), the built-in CPU 51 checks if the effective bit is set to 1 (S72) When the effective bit is not set to 1 (NO in S72), the process goes back to step S71. On the other hand, when the effective bit is set to 1 (YES in S72), the built-in CPU 51 instructs the PCI I/F 52 to transfer the IE stored in the IE setting region 21 to the frame buffer 54 (S73). The PCI I/F 52 transfers the IE to the frame buffer 54 using the address set in the host control register 53. The built-in CPU 51 sets the effective address to zero (S74) and adds the IE to the beacon which will be transmitted next (S75).

On the other hand, when it is the head of the superframe (YES in S71), the built-in CPU 51 instructs the device side I/F 55 to transmit the beacon by the own slot (MAS) (S76) The built-in CPU 51 sets the beacon that transmits the response ID next in the frame buffer 54 (S79). When the beacon period is not completed (NO in S77), it is checked if there is a received beacon in the frame buffer 54 (S80). When there is no received beacon (NO in S80), the process goes back to step S77. When there is a received beacon (YES in S80), the built-in CPU 51 instructs the PCI I/F 52 to transfer the beacon stored in the frame buffer 54 to the received beacon storing region 22 (S81), and the process goes back to step S77.

When the beacon period is terminated (YES in S77), it is checked if the negotiation IE is being transmitted (S78). When it is transmitted (YES in S78), the countdown value (Trade Countdown in the negotiation IE) is decremented by 1 (S82). When the countdown value is zero or more (YES in S83), the negotiation IE is added to the beacon which will be transmitted next (S84); and when the countdown value is less than zero (NO in S83), the negotiation IE is not added to the beacon which will be transmitted next (S85). The built-in CPU 51 sets the beacon which will be transmitted next in the frame buffer 54 (S79). Although the built-in CPU 51 in the Target side performs the similar operation as shown in FIG. 15, the following point is different. It is determined whether the negotiation IE is being received in step S78. Further, the response IE is employed in place of the negotiation IE in steps S84 and S85.

As described above, by designating the MAS in which the assignment negotiation or the exchange negotiation is required as the DRP Allocation of the negotiation IE to transmit it in the beacon period, the assignment negotiation or exchange of the MASs can be started. Further, by adding the countdown value to the negotiation IE and decrementing the value (performing countdown) by one for each superframe, the Owner side measures the negotiation period. Further, the Target side is able to detect the timing at which the MASs are assigned or exchanged and the response IE is transmitted based on the countdown value.

The Owner side receives the response IE from the device which will be the negotiating partner, which means the negotiation is successfully established, and the MAS that is changed is used from a superframe next to the superframe in which the countdown value becomes zero. When the countdown value becomes zero without any response, it means that the negotiation is not successfully established. Further, although not described in FIG. 14, the device in the Target side transmits the response IE when the countdown value is three or more. When the countdown value is two or less, no response is made. This is because it is natural in the radio transmission path to consider the failure of the transfer operation, and assumes the failure of up to three times consecutively. When the response is started when the countdown value is 3, it is possible to transmit the response IE four times until when the countdown value becomes zero.

As stated above, according to the exemplary embodiment of the present invention, it is possible to secure the required bandwidth by offering the slots reserved by the other devices to the own device, whereby the communication quality can be secured. Further, by collecting the slots to be made consecutive, large-volume data can be transferred and the transfer efficiency is enhanced.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A communication device comprising:
a control part that generates negotiation request information, the negotiation request information requesting a reservation change so that an own device uses a slot having been reserved by an other communication device; and
a host controller that sends the negotiation request information to the other communication device and receives a response accommodating the reservation change from the other communication device,
wherein, after receiving the response, the control part sets a slot reserved by the other communication device as a slot used by the own device.

2. The communication device according to claim 1, wherein the control part generates information requesting to assign a slot having been reserved by the other communication device, synchronizes with the other communication device after receiving the response, and gets the slot having been reserved by the other communication device from the other communication device.

3. The communication device according to claim 1, wherein the control part generates information requesting to change a slot having been reserved by the own device with a slot having been reserved by the other communication device, as the negotiation request information.

4. The communication device according to claim 1, wherein the control part sends the negotiation request information repeatedly during a predetermined period, and starts to use the slot having been reserved by the other communication device after the predetermined period.

5. The communication device according to claim 1, wherein the negotiation request information includes an own slot number area to set a slot number having been reserved by the own device, and an other slot number area to set a slot number having been reserved by the other communication device,
the control part sets a slot number requesting to use a slot on the other slot number area, and
in a case where the control part requests the other 10 communication device to exchange a slot, the control part sets the slot number having been reserved by the own device in the own slot number area.

6. The communication device according to claim 4, wherein the negotiation request information includes a countdown value to count the predetermined period,
the control part sets a number of super frames sending the negotiation request information to the countdown value,
the host controller reduces by one countdown the countdown value each time a super frame changes, and
when the control part receives a response and the countdown value becomes less than zero, the control part sets the slot having been reserved by the other communication device as the slot used by the own device.

7. The communication device according to claim 1, wherein
the host controller receives negotiation request information sent by the other communication device, the negotiation request information requests to change a reservation so that the other communication device uses a slot having been reserved by the own device, and
the control part determines whether or not the control part responds the negotiation request information sent by the other communication device in response to a slot reserved by the own device.

8. The communication device according to claim 1, wherein the slot is a Medium Access Slot (MAS).

9. The communication device according to claim 1, wherein the slot is reserved based on Ultra-wideband (UWB).

10. The communication device according to claim 9, wherein the slot is reserved based on WiMedia_Alliance.

11. A communication method comprising:
sending negotiation request information from a first device to a second device, the negotiation request information requesting to change a reservation so that the first device uses a slot having been reserved by the second device;
responding an acceptance of a reservation change by the second device based on the negotiation request information; and
using the slot having been reserved by the second device by the first device after making a response.

12. An information data structure that is tangible embedded in a computer readable medium, the information data structure comprising a data frame to be included in a beacon, wherein the data of the data frame specifies a slot number having been reserved by a first device and a reserved slot number having been reserved by a second device so as to change each other.

13. A storage medium stores instructions for the method of claim 11.
